(19) United States
(12) Patent Application Publication
(10) Pub. No.: US 2009/0201125 A1
(43) Pub. Date: Aug. 13, 2009

(54) Electronic device provided with theft prevention function, and method for preventing theft of electronic devices

(75) Inventors: Yasuyuki Ikeguchi, Itami City (JP); Hiroki Gakumura, Forrest City, AR (US)

Correspondence Address: MASUVALLEY & PARTNERS, 8765 AERO DRIVE, SUITE 312, SAN DIEGO, CA, 92123, US

(73) Assignees: Sanyo Electric Co., Ltd., Moriguchi City (JP); Sanyo Visual Technology Inc., Daito City (JP)

(21) Appl. No.: 12/069,357

(22) Filed: Feb. 8, 2008

(51) Int. Cl. G05B 19/04

(52) U.S. Cl. 340/5.2

(57) ABSTRACT

An electronic device includes a memory storing a first lock release code, a comparing portion comparing the first lock release code with a second lock release code that is input with an input device, a controlling portion permitting the electronic device to operate normally if the comparing portion finds that the first lock release code matches the second lock release code, and a restricting portion restricting an acceptance of an input of the second lock release code after input attempts have been made a predetermined number of times if the comparing portion finds that the first lock release code does not match the second lock release code.

### BACKGROUND OF THE INVENTION

1. Field of the Invention

The present invention relates to an electronic device provided with theft prevention function, and to a method for preventing theft of electronic devices.

2. Description of Related Art

Conventionally, a typical method for preventing theft of electronic devices is to, for example, embed a sensor called a sensor tag in a piece of merchandise or to attach the sensor tag to a carton case of the merchandise, and install a sensor in the doorway of a store to detect and sound a buzzer when the merchandise is removed from the store without deactivating the function of the sensor at a cash register. However, questions are raised about the effectiveness of this method because the sensor tag loses its effect once it is detached, and the electronic devices are nevertheless stolen even if the buzzer goes off.

And, JP-A-2007-81669 discloses a method for preventing theft of a television receiver. This invention is to directed to a method of storing the contact information of a user in a television receiver, and informing the user of theft via a network if the television receiver is judged to have been stolen.

Also, JP-A-2001-347894 discloses a theft prevention method for use in a motor vehicle. In this invention, in-vehicle electrical components are disabled once a vehicle is put on the alert in case of theft. Thereafter, the in-vehicle electrical components remain disabled unless they are brought out of the disabled state in some way. The method for bringing the in-vehicle electrical components out of the disabled state is to match a unique signal stored in the antitheft device on the vehicle with an unique signal stored in a memory provided separately.

Further, U.S. Pat. No. 4,987,594 discloses an invention which makes a radio receiver or a television receiver unusable by blocking a reception signal or generating a sound if no permission for the use is given, and thereby prevents theft of these receivers.

However, none of these inventions described above is adequate to prevent theft of electronic devices from stores.

It is for this reason that, as an electronic device having a function of preventing theft of electronic devices from stores, an electronic device has been proposed that is permitted to operate normally only when a first lock release code that is previously stored in a memory thereof matches a second lock release code that is input with an input device (U.S. patent application Ser. No. 11/895849). An authorized purchaser can use the electronic device without any problem because they can get a correct second lock release code in the store, for example. By contrast, a person who is not an authorized purchaser cannot operate the electronic device normally because they cannot input a correct second lock release code. In this way, this electronic device produces an effect of preventing theft of electronic devices from stores.

To unlock this electronic device, an authorized purchaser is required to input the second lock release code to the electronic device by using, for example, a remote control transmitter. In doing so, however, the authorized purchaser may inadvertently input an incorrect second lock release code. With consideration given to such possibilities, this electronic device has to be so designed that, based on the assumption that an incorrect second lock code may be input, the second lock release code can be input several times.

However, in general, there are restrictions on the number of digits of the lock release code, and the total number of codes is limited. As a result, the following problem arises. If an unlimited number of input attempts is permitted, anyone can release the lock by random input attempts, despite them not being an authorized purchaser. In recent years, a so-called “intelligent remote control transmitter” has come along that can voluntarily generate remote control codes and automatically transmit them to an electronic device such as a television receiver with control by a personal computer or the like. The advent of such a remote control transmitter makes it easy to make random input attempts automatically. It is under this background that it becomes increasingly necessary for the electronic device having a function of preventing theft of electronic devices to take a countermeasure against random input attempts.

As a countermeasure against random input attempts, there is a method of limiting the number of inputs of the lock release code. For example, in a case where the lock release code has been incorrectly input three times, a further input of the lock release code is disabled, making it impossible to carry out any operations.

However, these countermeasures against random input attempts may create disadvantage for the authorized purchaser, because there is a possibility that even the authorized purchaser fails to input a correct lock release code. Specifically, with the method of limiting the number of inputs of the lock release code, in a case where an incorrect lock release code has been input a given number of times, the authorized purchaser may be prohibited from using the electronic device due to a minor mistake they made.

### SUMMARY OF THE INVENTION

According to one aspect of the present invention, an electronic device is provided with: a memory storing a first lock release code; a comparing portion comparing the first lock release code with a second lock release code that is input with an input device; a controlling portion permitting the electronic device to operate normally if the comparing portion finds that the first lock release code matches the second lock release code; and a restricting portion restricting an acceptance of an input of the second lock release code after input attempts have been made a predetermined number of times if the comparing portion finds that the first lock release code does not match the second lock release code.

Preferably, the restricting portion does not accept an input of the second lock release code for a predetermined time.

Preferably, the predetermined number of times is programmable.

Preferably, the predetermined time is programmable.

An example of the electronic device is a television receiver.

Preferably, the input device is a remote control transmitter provided separately from the electronic device, and the electronic device includes a receiving portion for receiving a signal transmitted from the remote control transmitter.

According to another aspect of the present invention, a method for preventing theft of an electronic device is provided with the steps of: storing a lock release code in a memory of the electronic device; generating information corresponding to the lock release code stored in the memory; making the electronic device request an input of the information corresponding to the lock release code; comparing the input information with the lock release code stored in the memory; permitting the electronic device to operate normally if the input information is found to match the lock release code in the comparing step; and restricting an acceptance of the input information after input attempts have been made a predetermined number of times if the input information is found not to match the lock release code in the comparing step.

Preferably, in the restricting step, the input information is not accepted for a predetermined time.

Preferably, the predetermined number of times in the restricting step is programmable.

Preferably, the predetermined time in the restricting step is programmable.

An example of the electronic device is a television receiver.

Preferably, an input device for inputting the information corresponding to the lock release code is a remote control transmitter provided separately from the electronic device, and the electronic device includes a receiving portion for receiving a signal transmitted from the remote control transmitter.

### BRIEF DESCRIPTION OF THE DRAWINGS

FIG. 1 is a block diagram of a television receiver according to the present invention.

FIG. 2 shows a portion of a production process of the television receiver shown in FIG. 1.

FIG. 3 shows a procedure for issuing information corresponding to a lock release code.

FIG. 4 shows an example of a flowchart of operation of the television receiver shown in FIG. 1.

FIG. 5 is an example of a screen in which a television receiver requests an input of information corresponding to a lock release code.

FIG. 6 shows an example of a screen when a user inputs information which does not match a lock release code.

FIG. 7 is an example of a screen when the number of incorrect inputs exceeds a number limit.

### DETAILED DESCRIPTION OF PREFERRED EMBODIMENTS

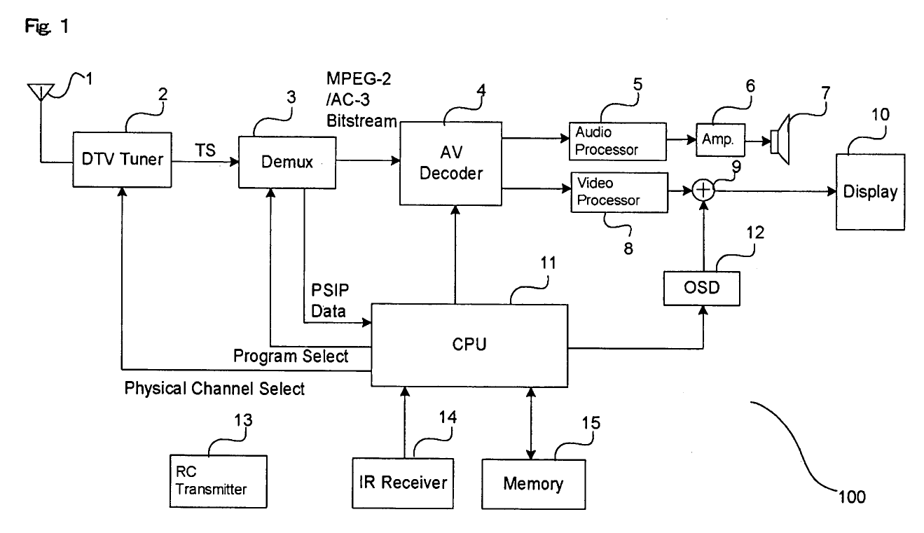

FIG. 1 shows a block diagram of a television receiver 100 according to the present invention. In this embodiment, an U.S. digital television receiver which receives an ATSC (Advanced Television Systems Committee) signal is described as an embodiment.

A terrestrial antenna 1 receives a digital terrestrial broadcasting wave, and supplies a received signal to a digital terrestrial tuner 2. The digital terrestrial tuner 2 selects a physical channel by a channel select signal from a CPU or a microprocessor 11. The digital terrestrial tuner 2 converts a high frequency 8VSB (8-level vestigial sideband) digital modulation signal including video/audio data to a specific frequency signal by this channel select process. Also, the digital terrestrial tuner 2 is provided with an 8VSB demodulation circuit or the like to demodulate the digital modulation signal of selected physical channel, and outputs a transport stream TS.

A demultiplexer (DEMUX) 3 divides the transport stream TS received from the digital terrestrial tuner 2 into a predetermined packet, namely a video stream of MPEG-2, an audio stream of AC-3 (AC-3 is a registered trade mark of Dolby Laboratories Licensing Corporation), and PSIP (Program and System Information Protocol) data, and receives a program select signal from the CPU 11. The demultiplexer 3 supplies the video stream and the audio stream to an AV decoder 4, and PSIP data, which includes program information, is supplied to the CPU 11.

The CPU 11 performs various controls of the television receiver 100, as well as processing of the PSIP data, and processing of remote control signals described later. A memory 15 is connected to the CPU 11, and the memory 15 stores various data including the program information and a lock release code described later.

A plurality of virtual channels are multiplexed into the transport stream TS, and selection of any one of the plurality of virtual channels is made possible by collecting the VCT (virtual channel table) from the transport stream TS and identifying a given packet ID by referring to the VCT thus collected.

An AV decoder 4 is provided with an MPEG video decoder (not shown) for decoding the MPEG-2 bit stream, and an AC-3 decoder (not shown) for decoding the audio stream (AC-3 bit stream). The video data generated by the decoder of AV decoder 4 is output to a video processor 8, and the audio data is output to an audio processor 5.

The video processor 8 receives the video data from the AV decoder 4 and generates a video signal by performing D/A conversion. The audio processor 5 receives the audio data output from the AV decoder 4 and generates an analog audio signal by performing D/A conversion.

An OSD (On Screen Display) circuit 12 outputs a video signal to an adder 9 based on the character information instructed to output from the CPU 11. The adder 9 adds the video signal based on the bitmap data and the reception video signal, and supplies the resultant video signal to a display 10, such as an LCD.

The display 10 displays images according to the video signal supplied from the video processor 8. Also, the analog audio signal from the audio process circuit 5 is output from a speaker 7 after being amplified with an amplifier 6.

A remote control transmitter 13 is a transmitter to transmit various instructions to the television receiver 100. When a key (not shown) provided on this remote control transmitter 13 is operated, an IR (Infrared) signal (remote control signal), which is an instruction corresponding to the key, is transmitted from a light emitting portion (not shown). An IR receiver 14 receives the signal light, converts it into an electrical signal, and supplies it to the CPU 11.

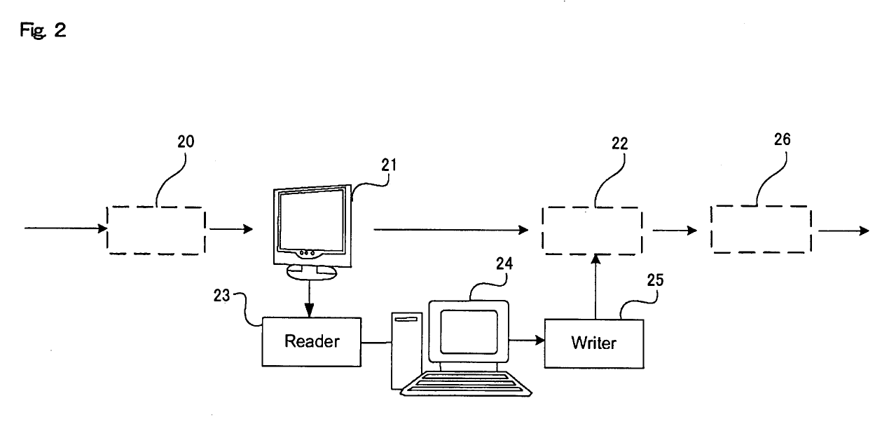

FIG. 2 shows a portion of a production process of the television receiver shown in FIG. 1. Each television receiver manufactured in a factory may be provided with a serial number. The serial number may be provided by attaching a barcode indicating the serial number onto the main body of the television receiver. The code other than a barcode, such as a two-dimensional code, may be used instead.

As shown in FIG. 2, the television receiver which was subjected to a predetermined process in a manufacturing process 20 is transferred to the next manufacturing process 21. In the manufacturing process 21, the barcode indicating the serial number provided to the television receiver is read by a barcode reader 23. And the serial number is input to a PC (personal computer) 24. The PC 24 has software which is capable of generating different lock release codes, one for each of the serial numbers. The PC 24 creates the lock release code with the software. The created lock release code is transferred to a writer 25.

In a manufacturing process 22, the lock release code is written in the memory 15 of the television receiver by the writer 25. This writer 25 may be a remote controller transmitting portion to transmit the signal of the lock release code received from the PC 24 as an infrared remote control signal. The lock release code transmitted from the writer 25 is received by the IR receiver 14 of the television receiver and stored in the memory 15 through the CPU 11 (shown in FIG. 1). The television receiver storing the lock release code is delivered as goods (process 26).

In this way, one lock release code corresponds to one serial number and is stored in the television receiver. In addition, the information corresponding to the lock release code is generated. The serial number, the information corresponding to the lock release code, and the lock release code correspond to one another. Also, the information corresponding to the lock release code and the lock release code are generated to match.

Reading of the serial number may be in any form. For example, an IIC bus may be used. That is, the serial number is written in the memory 15 of the television receiver in the manufacturing process 20, and the serial number is read into the PC 24 through the IIC bus in the manufacturing process 21.

A lock release code corresponding to the serial number is generated in the PC 24, and the lock release code thus generated may be written on the memory 15 of the television receiver by the IIC bus. Also, the information to create the lock release code is not limited to the serial number, it may be anything. It may be the date of manufacture of the television receiver. The method for generating the lock release code is not limited to that of FIG. 2, it may be any method.

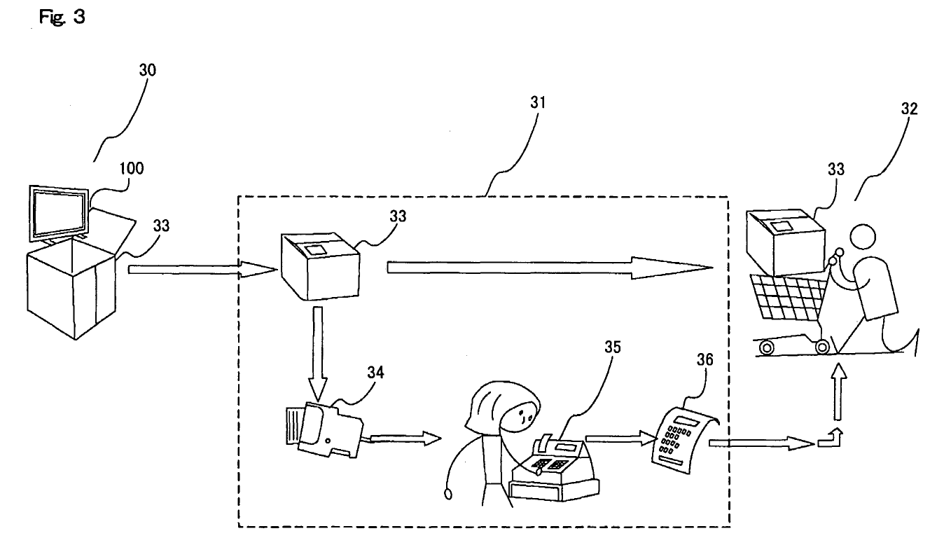

FIG. 3 shows a procedure for issuing the information corresponding to the lock release code. In a manufacturing process 30, the television receiver 100 is packaged. In a sales process 31, the barcode indicating the serial number attached to the packaged television receiver 33 is read by a barcode reader 34. The read serial number is imported to a register device 35. The register device 35 is capable of obtaining the information corresponding to the lock release code from an individual serial number. The obtained information corresponding to the lock release code is printed on a receipt 36 which indicates a record of purchase, and handed to a purchaser (process 32).

The information corresponding to the lock release code is not necessarily printed on a receipt, and it may be given to a purchaser in any form. For example, it may be printed on a separate form from the receipt. Also, reading the serial number is not limited to the barcode reader, it may be transmitted to a register in any form. For example, the serial number may be input to a register directly by a store clerk. Also, instead of transmitting the serial number to the register, the information corresponding to the lock release code may be obtained by transmitting the serial number to another device. Also, the number other than the serial number may be used and it may be in any form, or a time to obtain the information corresponding to the lock release code may be in any form.

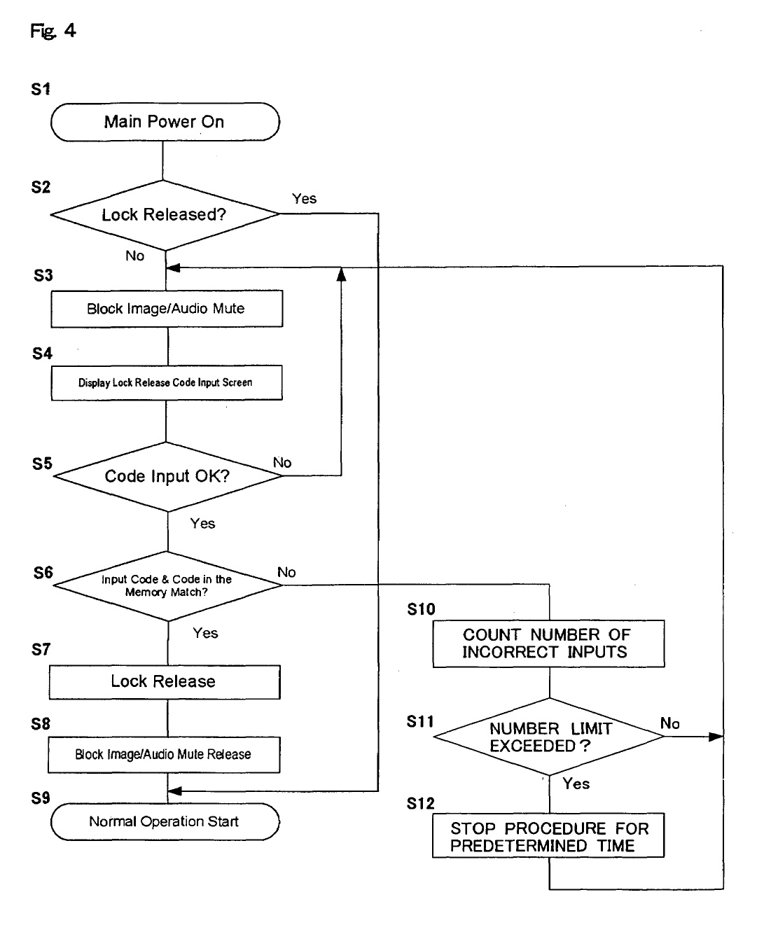

FIG. 4 shows an example of a flowchart of the operation of the television receiver shown in FIG. 1. First, when the power of the television receiver is turned on (step S1), the CPU 11 of the television receiver checks if the lock for images and so on has been released or not (step S2). If the lock is found to have been released, the television receiver starts channel select preset operation, image display, and audio output (step S9). If the CPU 11 of the television receiver finds that the lock for the image display and so on has not been released, the image is blocked and the sound is muted (step S3).

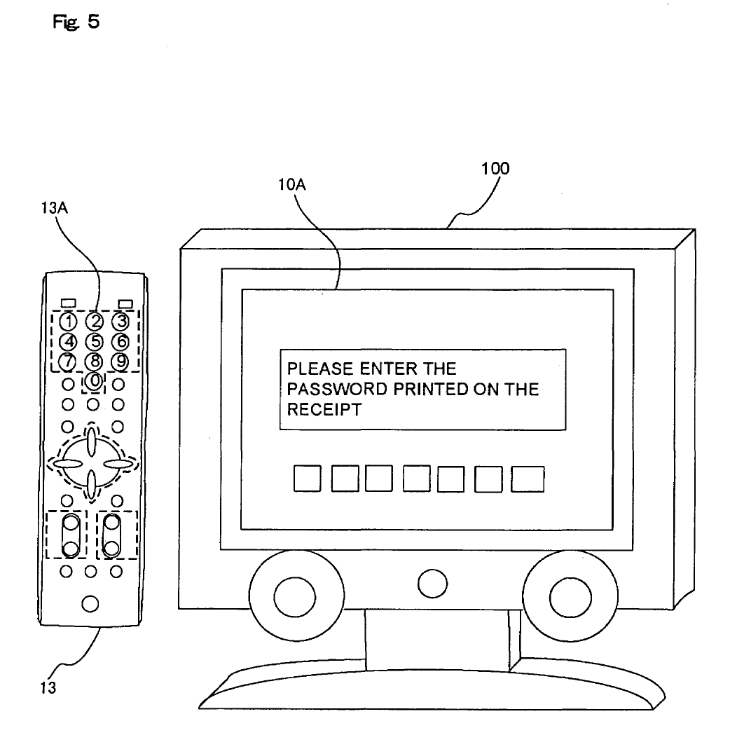

Thereafter, for example, a display requesting an input of the information corresponding to the lock release code is displayed on the screen of the television receiver as explained in FIG. 5 (step S4). The user inputs the information corresponding to the lock release code by using a remote controller or the like according to this instruction. Then, the television receiver determines whether there is an input from the user or not (step S5). When there is no input, the image and the audio are blocked (step S3).

When there is an input, a determination is made at the comparing portion of the television receiver as to whether the information matches the lock release code or not (step S6). Incidentally, in this embodiment, the CPU 11 of the television receiver functions as the comparing portion of the television receiver. When it is determined that the information matches the lock release code, the lock for the image and the audio is released (step S7). When the lock is released, the image block and the audio mute are released (step S8), the television receiver starts a channel select preset operation, image display, and audio output (step S9).

When it is determined that the information does not match the lock release code, the CPU 11 of the television receiver counts how many times the information corresponding to the lock release code is incorrectly input, and then stores the number of incorrect inputs in the memory 15 (step S10). Then, the CPU 11 of the television receiver checks whether the number of incorrect inputs exceeds a number limit previously stored in the memory 15 or not (step S11). If the number of incorrect inputs falls within the number limit, the procedure goes back to step S3, and the next input attempt is waited for. If the number of incorrect inputs exceeds the number limit, the procedure is stopped for a predetermined waiting time previously stored in the memory 15 (step S 12). After a lapse of the waiting time, the procedure goes back to step S3, and the next input attempt is waited for.

For example, let the number limit in step S11 be ten, and the predetermined waiting time in step S12 be one minute. Then, the authorized purchaser is allowed to input the information corresponding to the lock release code up to ten times with no restriction, whereas, in subsequent input attempts, a person who is not an authorized purchaser and is trying to release the lock by random input is made to wait for one minute after each input attempt.

The authorized purchaser who knows the correct information corresponding to the lock release code can usually succeed in releasing the lock if given ten input attempts, and hence does not experience inconvenience. Even if the authorized purchaser fails to input the correct information in ten input attempts, they are allowed to use the television receiver shown in FIG. 1 if they input the correct information corresponding to the lock release code in an eleventh or subsequent input attempt. Therefore, the authorized purchaser does not suffer any disadvantage.

On the other hand, for a person who is not an authorized purchaser and is trying to release the lock, setting an appropriate number limit and waiting time is satisfactorily effective in preventing theft. For example, suppose that the lock release code is a five-digit number. In that case, a person who is not an authorized purchaser and is trying to release the lock needs one hundred thousand input attempts to try all the possible lock release codes, and it takes about 1660 hours to do that because they are made to wait for one minute after each input attempt for an eleventh and subsequent input attempt. It should be noted that the number limit and waiting time are not limited to the examples specifically described above. The number limit and waiting time may be appropriately adjusted based on the requirements such as the total number of lock release codes of the electronic device according to the invention, such that an appropriate theft prevention effect is obtained.

Advisably, at least part of the memory 15 is built with a rewritable nonvolatile memory, and the number limit in step S11 and the predetermined waiting time in step S12 are stored in this rewritable nonvolatile memory. This makes the number limit in step S11 and the predetermined waiting time in step S12 programmable, making it easy to support various variations.

FIG. 5 shows an example of a screen in which the television receiver is requesting an input of the information corresponding to a lock release code. FIG. 5 shows a television receiver 100 and a remote control transmitter 13, which is an example of the remote controller. The remote control transmitter 13 has a plurality of inputs 13A. The television receiver 100 has a display screen 10A. The display screen 10A is displaying “Please enter the password printed on the receipt”.

A user inputs the information corresponding to the lock release code using the remote control transmitter 13 according to the instruction of the display screen 10A. When the input information matches the lock release code stored in the memory of the television receiver 100, an image is displayed on the display screen 10A. When the input information does not match the lock release code, there is no image display or audio output. The plurality of inputs 13A include an input to correct the input, an input to reset the television receiver 100 to an initial state, and a confirmation key to confirm a predetermined item.

The means for inputting the information is not limited to the example specifically described above, it may be in any form. For example, instead of using the controller, the inputs provided to the television receiver may be used. Also, the display screen to request a user to input the information may be in any form. For example, in a case where there are a plurality of numbers to be input, the display screen shows a few numbers (for example three numbers) for each of the plurality of numbers to be input, and then shows an input screen for the next numbers. Also, numbers may be displayed on the display screen, and a user may select appropriate numbers by touching the screen where the numbers exist. Also, a column to draw a symbol or simple picture may be displayed on the display screen, and the user may draw the information in the column.

The television receiver may request to enter the information at any time. For example, it may be when the power of the television receiver is turned on, or a few seconds after the power is turned on. Also, the input may be confirmed by using a confirmation key after inputting a plurality of numbers as the information. In such case, if the confirmation key is pressed before inputting all the numbers to be input, the display screen does not change and it may display a screen prompting to continue the input.

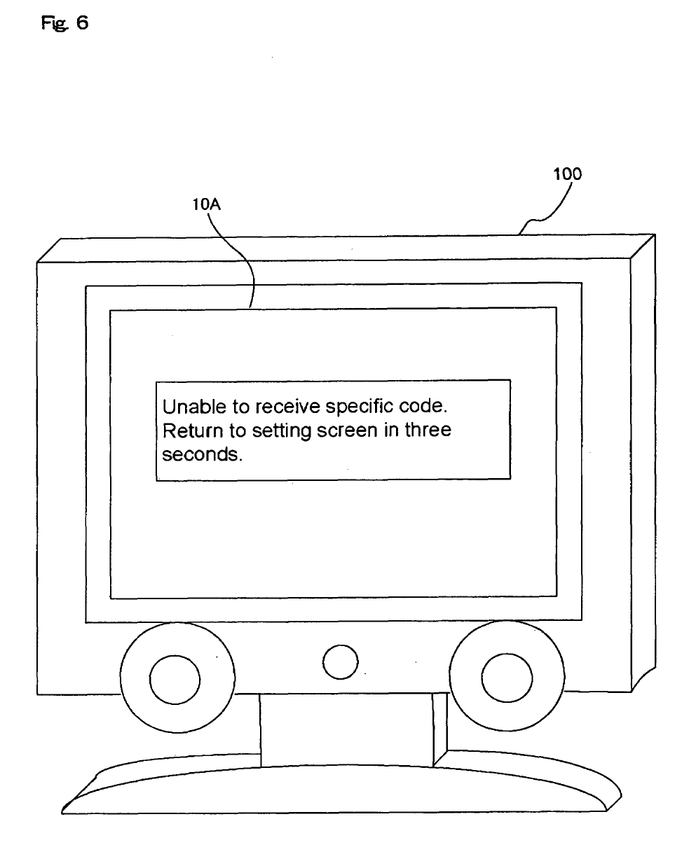

Between step S6 and step S10, a step for displaying a screen shown in FIG. 6, for example, may be provided. In the example shown in FIG. 6, the display screen 10A of the television receiver 100 displays a message “Unable to receive specific code. Return to setting screen in three seconds”, indicating that, since the user inputs the information which does not match the lock release code, an image is not displayed. The display in which the image display is blocked is not limited to that of FIG. 6, and it may be in any form. For example, an X mark may be displayed on the display screen. Also, for example, when the number of incorrect inputs of the information corresponding to the lock release code reaches a predetermined number (which is smaller than the number limit in step S11), contact information on a third party may be displayed. By contacting the third party and providing it with the information such as serial number, the user can obtain the information corresponding to the lock release code from the third party.

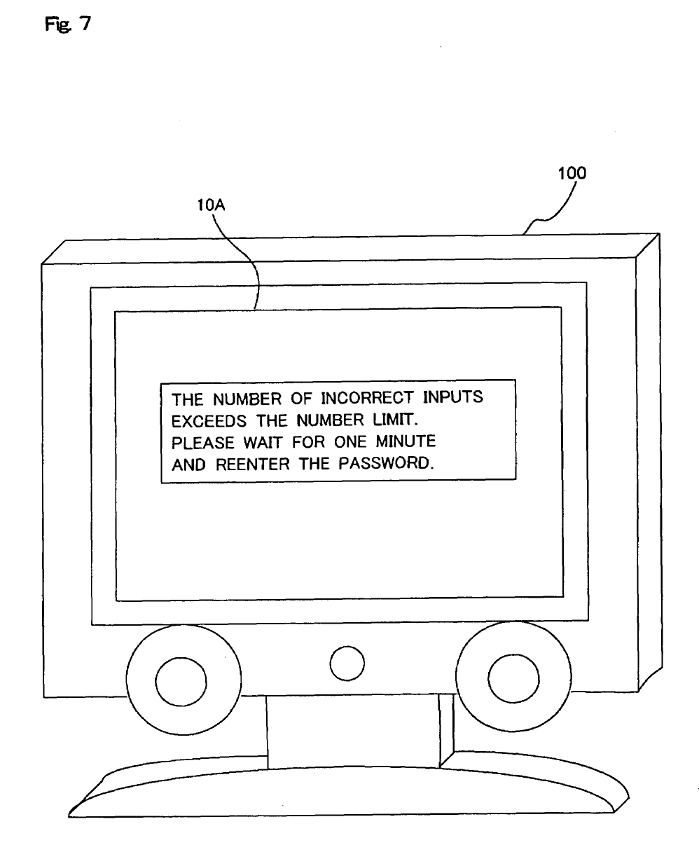

Between step S11 and step S12, a step for displaying a screen shown in FIG. 7, for example, may be provided. In the example shown in FIG. 7, the display screen 10A of the television receiver 100 displays a message “The number of incorrect inputs exceeds the number limit. Please wait for one minute and reenter the password”. The display that appears when the number of incorrect inputs exceeds the number limit is not limited to that of FIG. 7, and it may be in any form. For example, a message “Please wait” may be displayed on the display screen.

The present invention is not limited to the embodiment above. For example, only a television receiver is explained in FIGS. 1 to 7; however, the explanations in FIGS. 1 to 7 may be applied to all the electronic devices, such as VCRs, DVD players, camcorders, vacuum cleaners, electric heaters, air conditioners, rice cookers, digital cameras, land-line phones, cellular phones, personal computers, and electric fans. Also, the electronic devices may be provided with a solar cell.

What is claimed is:

1. An electronic device, comprising:
a memory storing a first lock release code;
a comparing portion comparing the first lock release code with a second lock release code that is input with an input device;
a controlling portion permitting the electronic device to operate normally if the comparing portion finds that the first lock release code matches the second lock release code; and
a restricting portion restricting an acceptance of an input of the second lock release code after input attempts have been made a predetermined number of times if the comparing portion finds that the first lock release code does not match the second lock release code.

2. The electronic device as claimed in claim 1, wherein
the restricting portion does not accept an input of the second lock release code for a predetermined time.

3. The electronic device as claimed in claim 1, wherein
the predetermined number of times is programmable.

4. The electronic device as claimed in claim 2, wherein
the predetermined time is programmable.

5. The electronic device as claimed in claim 1, wherein
the electronic device is a television receiver.

6. The electronic device as claimed in claim 1,
wherein the input device is a remote control transmitter provided separately from the electronic device,
wherein the electronic device comprises a receiving portion for receiving a signal transmitted from the remote control transmitter.

7. A method for preventing theft of an electronic device, comprising the steps of:
storing a lock release code in a memory of the electronic device;
generating information corresponding to the lock release code stored in the memory;
making the electronic device request an input of the information corresponding to the lock release code;
comparing the input information with the lock release code stored in the memory;
permitting the electronic device to operate normally if the input information is found to match the lock release code in the comparing step; and
restricting an acceptance of the input information after input attempts have been made a predetermined number of times if the input information is found not to match the lock release code in the comparing step.

8. The method for preventing theft of an electronic device as claimed in claim 7, wherein
in the restricting step, the input information is not accepted for a predetermined time.

9. The method for preventing theft of an electronic device as claimed in claim 7, wherein
the predetermined number of times in the restricting step is programmable.

10. The method for preventing theft of an electronic device as claimed in claim 8, wherein
the predetermined time in the restricting step is programmable.

11. The method for preventing theft of an electronic device as claimed in claim 7, wherein
the electronic device is a television receiver.

12. The method for preventing theft of an electronic device as claimed in claim 7,
wherein an input device for inputting the information corresponding to the lock release code is a remote control transmitter provided separately from the electronic device,
wherein the electronic device comprises a receiving portion for receiving a signal transmitted from the remote control transmitter.
